(19) United States
(12) Patent Application Publication
(10) Pub. No.: US 2007/0064856 A1
(43) Pub. Date: Mar. 22, 2007

(54) NeuX nuclear power systems

(76) Inventor: Willard H. Schmidt, Albuquerque, NM (US)

Correspondence Address: Willard H. Schmidt, 2015 Altez NE, Albuquerque, NM, 87112, US

(21) Appl. No.: 11/206,320

(22) Filed: Aug. 18, 2005

(51) Int. Cl. G21B 1/00

(52) U.S. Cl. 376/100

(57) ABSTRACT

The subject invention nuclear power systems consist of containers, or cells, filled with Neu2 particles. The particles are caused to interact in a high collision density that results from shock waves created by high explosives or strong electrical pulses on the cell casing. Neu2 particle interaction, or nuclear fusion of the particles, results in a release of so called binding energy. This new nuclear power system can serve as a source of power for commercial and industrial applications. The light weight and high power density systems are especially attractive for airplanes and spacecraft applications.

### BACKGROUND—DESCRIPTION OF PRIOR ART

This patent application is preceded by an application in my name titled “Neutron Beam Interaction Station and Components”. The nuclear fission process was discovered in 1938 by Otto Hahn, Fritz Strassmann, and Lisa Meitner at the Kaiser Wilhelm Institute in Germany. It was preceded by the discovery of the neutron by James Chadwick in 1932. The first nuclear fission chain reaction pile was built under the direction of Enrico Fermi at the University of Chicago in 1942. Presently there are 102 operating nuclear power plants that produce about 20% of the electrical power used in this country. These power plants use the nuclear fission process and require enriched uranium fuel. No power plants anywhere in the world today use the nuclear fusion process.

This subject patent application is based on a neutron nuclear fusion process. Hydrogen nuclear fusion processes in the sun are well known. They require very high temperatures and pressures to overcome the Coulomb electrical force in order to fuse together hydrogen atoms.

### DRAWING FIGURES

FIG. 1 is a cross section view showing a Neu2 energy cell with an elliptically shaped case. A high explosive detonator is located at each end of the case.

FIG. 2 illustrates a Neu2 spherical energy cell with a high explosive blanket over the case.

FIG. 3 illustrates a Neu2 spherical energy cell with a spherical booster cell located at the center.

FIG. 4 shows a Neu2 spherical energy cell prepared for detonation with electrodes in four positions on the periphery of the cell.

FIG. 5 is a cross section view of a Neu2 spherical implosion array of Neu2 energy cells covered by a high explosive blanket.

### REFERENCE NUMERALS IN FIGS.

1. Elliptical shaped energy cell case
2. High explosive detonator
3. Spherical shaped energy cell case
4. High explosive blanket
5. Spherical booster cell
6. Spherical power cell
7. Electrical source
8. Electrical cable
9. Electrode
10. Intermediate spherical power cell
11. Center spherical power cell

### DESCRIPTION OF INVENTION

A NeuX nuclear power system consists of NeuX particles within a container, or cell, in which the particles can interact to generate energy. Neu2 is the name of a particle with two neutrons joined together. The Neu2 power system operates by causing the Neu2 particles to interact with each other and release energy.

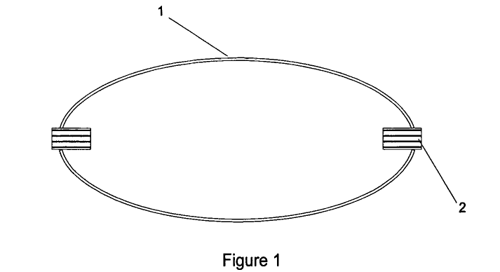

FIG. 1 shows an elliptical energy cell case 1 with high explosive detonators 2 located at each end.

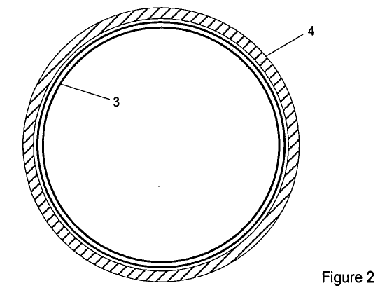

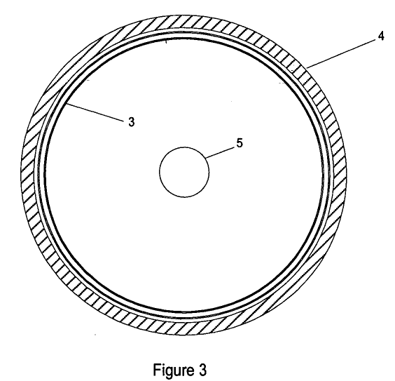

FIG. 2 shows a spherical energy cell case 3 that contains Neu2 particles. A blanket of high energy explosive 4 surrounds the outside surface of the cell case 3. FIG. 3 illustrates a spherical booster cell 5 at the center of the spherical energy case 3.

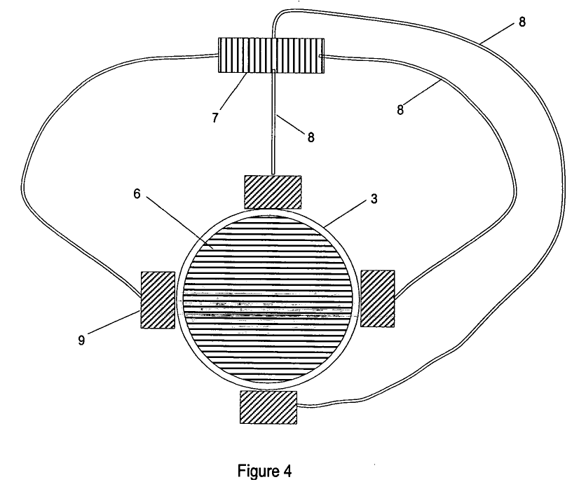

FIG. 4 illustrates a spherical energy power cell 6 that contains Neu2 particles within spherical energy cell case 3. Electrodes 9 are positioned on four sides of spherical energy cell case 3. They are powered and controlled by electrical source 7 through electric cables 8.

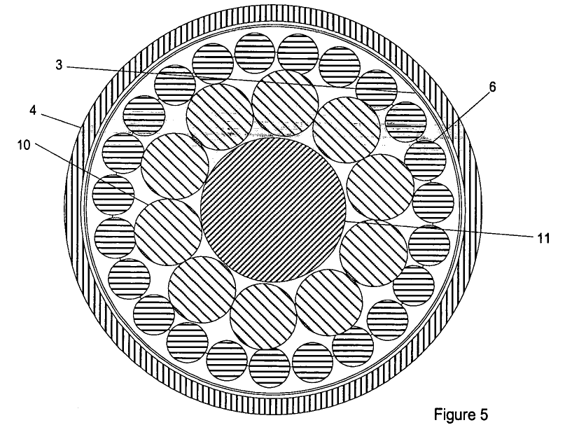

A spherical implosion energy cell array is shown in FIG. 5. The center spherical power cell 11 is located at the center of the spherical array. The entire array is located inside of spherical energy cell case 3 that has a high explosive blanket 4 on the outside surface. Just inside of spherical energy cell case 3 is located a region of spherical power cells 6. A region of intermediate spherical power cells 10 is located between the region of spherical power cells 6 and center spherical power cell 11.

### OPERATION OF INVENTION

The purpose of the subject invention “NeuX Nuclear Power Systems” is to generate energy by causing interactions, or fusion, between Neu2 particles within energy containment cells.

Each interaction releases about 30 Mev of so called binding energy. This is similar to hydrogen thermonuclear reactions in the sun. To overcome Coulomb electrical repulsion forces between hydrogen atoms, extremely high temperatures and pressures are required in the sun for hydrogen thermonuclear reactions to occur.

Neu2 particles do not have an electrical charge. Therefor, there is no Coulomb force to overcome for reactions to occur between particles. However, in order to get Neu2 particle interactions to occur, the particles must be brought together. This can be done by shock waves from high explosive detonators on a vessel containing Neu2 particles. See FIG. 1. Also, the probability for Neu2 particle interactions can be greatly increased by imploding Neu2 energy cells. This is accomplished by detonating a high explosive blanket on the surface of the cell case. FIGS. 2, 3, and 5 show models that illustrate case designs for implosion of Neu2 energy cells.

The energy from Neu2 interactions in a spherical energy cell can be used to implode and detonate a spherical cell of hydrogen deuterium and tritium atoms located at the center of a Neu2 spherical energy cell, as illustrated in FIG. 3.

FIG. 5 shows a model of a Neu2 spherical implosion array. The implosion shock wave is started by detonating a blanket of high explosive material on the outer surface of the spherical cell case. Interactions between Neu2 particles occur in the successive regions of Neu2 energy cells. The resultant shock waves combine to produce an implosion shock wave on the center spherical power cell to release a maximum amount of Neu2 interaction binding energy.

FIG. 4 shows a Neu2 spherical cell in an arrangement that can be used for repetitive firing or exploding of Neu2 energy cells to release energy. The energy cell is positioned between four electrodes located ninety degrees apart. The electrodes are energized by an electrical source and condenser to provide high voltage bursts to generate shock waves that cause the energy cell to implode and produce energy from the Neu2 particle reactions.

### CONCLUSIONS AND SCOPE OF INVENTION

The purpose of this invention is to provide a new, safe, and economical source of nuclear energy for commercial and industrial use. The light weight and high energy yield of energy cells in the system designs of this invention make possible a new and unique fuel especially attractive for space vehicles and for aircraft. All of the energy producing cells in this invention depend on interactions between Neu2 particles, The Neu2 particle interactions constitute a nuclear fusion process. The rates of interactions depend on the collision density of the Neu2 particles. The interaction rate in a Neu2 particle energy cell is never zero. The interaction rate is increased by increasing the particle density and kinetic velocity of particles in an energy cell. In this invention the collision density is increased by shock waves applied to the Neu2 energy cell by means of high explosive blankets and by pulsed electric energy discharges.

I claim:

1. NeuX nuclear power systems comprising containers, or cells, filled with Neu2 particles that can cause interactions of the Neu2 particles resulting in a release of binding energy by means of shock waves generated on the cell casing, or by implosion of the cell case from a blanket of high explosive material, or by a strong electrical pulse on the cell case.

2. The nuclear power systems of claim 1 comprising an elliptical shaped energy cell, containing Neu2 particles, with a high explosive detonator at each end.

3. The nuclear power systems of claim 1 comprising a spherical shaped energy cell, containing Neu2 particles, that has a high explosive material blanket on the surface of the cell case.

4. The nuclear power systems of claim 1 comprising a spherical shaped energy cell, containing Neu2 particles and also a spherical booster cell containing deuterium and tritium gas, with a high explosive material blanket on the outer surface of the cell casing.

5. The nuclear power systems of claim 1 comprising a spherical or spheroid shaped energy cell, containing Neu2 particles, that has four electrodes equally spaced around the outer surface of the cell casing.

6. The nuclear power systems of claim 1 comprising an array of spherical energy cells, each containing Neu2 particles, with a central spherical power cell filled with Neu2 particles located at the center of the array, and the entire array of cells within a spherical casing covered with a blanket of high explosive material.

7. A nuclear energy cell with a spherical or spheroid shaped casing that is filled with Neu2 particles and is detonated by means of shock waves from pulsed electric power through electrodes spaced around the periphery of the cell casing as a basis for continuous power production.
